(19) United States
(12) Patent Application Publication
(10) Pub. No.: US 2020/0349659 A1
(43) Pub. Date: Nov. 5, 2020

(54) SHORT-, MEDIUM-, OR LONG-TERM OCCUPANT SPACE SYSTEM, METHOD, AND ARCHITECTURE

(71) Applicant: 3D Roomspace, INC, New York, NY (US)

(72) Inventors: Daniel Lowenberg, Los Angeles, CA (US); Gabriel Carter, New York, NY (US)

(21) Appl. No.: 16/865,278

(22) Filed: May 1, 2020

Related U.S. Application Data
(60) Provisional application No. 62/841,811, filed on May 1, 2019.

(51) Int. Cl. G06Q 50/16; G06Q 30/06; G06Q 10/10; G06Q 30/02; G06Q 20/36; H04L 9/32; G06T 19/00

(52) U.S. Cl. CPC G06Q 50/16; G06Q 30/0645; G06Q 10/10; G06Q 30/0282; G06Q 30/0627; G06Q 30/0633; H04L 2209/38; G06Q 30/0643; G06Q 20/3672; H04L 9/3226; G06T 19/006; G06Q 2220/00; G06Q 30/0639

(57) ABSTRACT

Embodiments of architecture, systems, and methods that enable a tenant or space provider to rent or offer for rent a space for short-, medium-, or long-term occupation including a room in a house, apartment, condominium, office for individual use or with roommates are described herein. Other embodiments may be described and claimed.

### TECHNICAL FIELD

Various embodiments described herein relate generally to architecture, systems, and methods used to enable users (renters) to find short-, medium-, and long-term occupant space and (tenant) users to lease or rent short-, medium-, and long-term occupant space.

### BACKGROUND INFORMATION

A person may want to rent or offer for rent a space for short-, medium-, or long-term occupation including a room in a house, apartment, condominium, office for individual use or with roommates, the present invention provides architecture, systems, and methods for such persons.

### BRIEF DESCRIPTION OF THE DRAWINGS

FIG. 1 is a block diagram of short-, medium-, or long-term occupant space (SMLTOS) architecture according to various embodiments.

FIGS. 2A-2C are diagrams of communications between an OSP systems, a SMLTOS system, and a cloud-CBCS according to various embodiments.

FIG. 3A is a block diagram of SMLTOS architecture communicating data to a main screen of an OPS system according to various embodiments.

FIGS. 3B-3T are diagrams of screens of an OPS system according to various embodiments.

FIG. 3U is a diagram of a virtual reality screen of an OPS system according to various embodiments.

FIG. 4 is a block diagram of a SMLTOS system according to various embodiments.

FIGS. 5A-5B are flow diagrams illustrating several methods according to various embodiments.

FIG. 6 is a block diagram of an article according to various embodiments.

FIG. 7 is a block diagram of an article according to various embodiments.

### DETAILED DESCRIPTION

Individuals (herein after tenant or occupant) may need or desire to obtain short-, medium-, or long-term housing or work space. A short-term lease may be less than one month. A medium-term lease may be range from over a month to about a year in an embodiment. A long-term lease may be for over 12 months in an embodiment. An individual, landlord, or company (herein after landlord or space provider) may need or desire to obtain short-, medium-, or long-term occupants for housing or work space. The tenant seeking space may be new to the location where they are seeking space. Further, a tenant may desire to seek space with roommates/officemates to limit costs and provide companionship in a new environment. In addition, a tenant or landlord may be seeking an occupant to share space in their home, apartment, condominium, or office. It can be difficult for tenants to locate spaces that are acceptable and more difficult to determine whether they may be compatible with potential roommates that may share space(s). Similarly, it can be difficult for landlords to find acceptable tenants especially where they may be potential roommates that may share space(s).

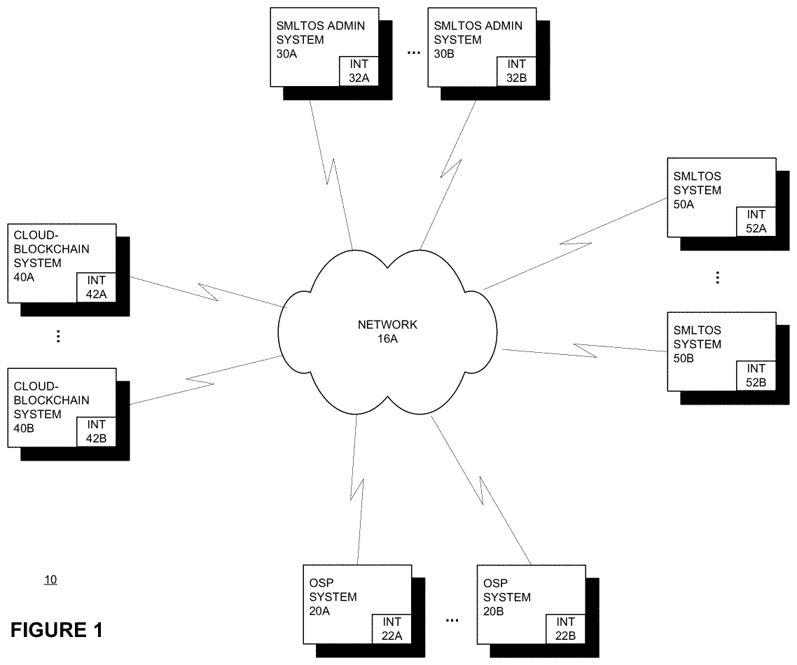

FIG. 1 is a block diagram of short-, medium-, or long-term occupant space (SMLTOS) architecture 10 according to various embodiments. As shown in FIG. 1, SMLTOS architecture 10 may include a plurality of tenant or occupant or landlord or space provider (OSP) systems 20A-20B, one or more SMLTOS admin systems (SAS) 30A-30B, one or more SMLTOS systems 50A-50B, and one or more cloud-blockchain systems (CBCS) 40A-40B. In an embodiment, the CBCS 40A-40B may include certificate authority entities that create or issue digital certificates. In an embodiment, the CBCS 40A-40B may employ cryptographically linked blocks in an open, distributed ledger termed blockchains and hereinafter systems 40A-40B are referred to as CBCSs although they could be any cryptographic provider, system, software, or entity and provide cloud services.

In an embodiment, an OSP system 20A-20B may communicate with a SMLTOS system 50A-50B via one or more networks 16A where the networks may be local wired or wireless networks or a network of networks such as the Internet. A SMLTOS system 50A-50B may communicate with a SAS 30A-30B and CBCS 40A-40B via a network 16A.

In an embodiment, a tenant via an OSP system 20A-20B (hereinafter 20A for simplicity) via a local application, real-time application, or web-based interface (such as browser) may interact with a SMLTOS system 50A. Similarly, a landlord or space provider via an OSP system 20A via a local application, real-time application, or web-based interface (such as browser) may interact with a SMLTOS system 50A. In embodiment, a tenant via an OSP system 20A may search for available spaces and a landlord may list available spaces via architecture 10. In addition, a tenant and landlord via an OSP system 20A may be able to provide real-time, event driven, or random feedback about the space, neighbors, environment, landlord, tenant, and other tenants (where spaces include roommates or workmates) in architecture 10. An administrator via a SMLTOS admin system 30A may be able to review any feedback provided by OPS system 20A users to ensure they are in compliance with architecture rules of posting 10. In an embodiment, an OPS system 20A user may also be able to request review of feedback where an administrator via a SMLTOS admin system 30A may act as an arbitrator when a dispute regarding feedback between OPS system 20A users exists.

In an embodiment, architecture 10 may employ a payment and reward system tied to electronic tokens created and stored in CBCS 40A. In an embodiment, rewards may be allocated or paid to tenants, space providers, and third-party vendors based on their interaction via architecture 10 and during the occupancy. The third-party vendors may provide services to related to the space associated with the tenant and space providers such as plumbers, electricians, painters, handyman, cleaners, and other providers. The tenants may be granted rewards for their relationship with other tenants and the landlord and for providing services related to the space. The rewards may be used to pay for rent of space in an embodiment. In an embodiment, tenants may be paid rewards for purchases and activities in their neighborhood about the respective space. The CBCS 40A may used to create tokens and store all related activity using open, distributed ledgers, i.e., blockchains including information about tenants, landlords, and spaces (current and historical).

In an embodiment, the SMLTOS 50A may not store any communications between users of OSP systems 20A other than processing to be stored by a CBCS 40A and provide real time software or code to be executed and data to be processed by an OSP system 20A. Only administrators and other authorized users of OSP systems 20A may see activity, postings, feedback, reward status, and other related information to protect the privacy of the OSP systems 20A users.

In an embodiment, the CBCS 40A-40B (hereinafter 40A for simplicity) may employ cryptographically linked blocks in an open, distributed ledger termed blockchains in addition to digital certificates from cryptography certificate authority entities. A CBCS system 40A employing blockchains (hereinafter CBCS 40A for simplicity) may generate digital certificates, identifiers (IDs), or tokens than are unique and tied and copied/distributed to a plurality of systems 40A to secure the digital certificates, identifiers (IDs), or tokens. Similarly, in an embodiment any updates associated with OSP systems 20A such as listings, rewards, payments, tenants and landlord information may be distributed across many systems 40A to prevent corruption of SMLTOS architecture 10 data and provide a secure and reproducible record or ledger of all activity along with the source of such changes. In an embodiment, each OSP system 20A user and every space or listing may be assigned a unique token that is created and stored by a CBCS 40A

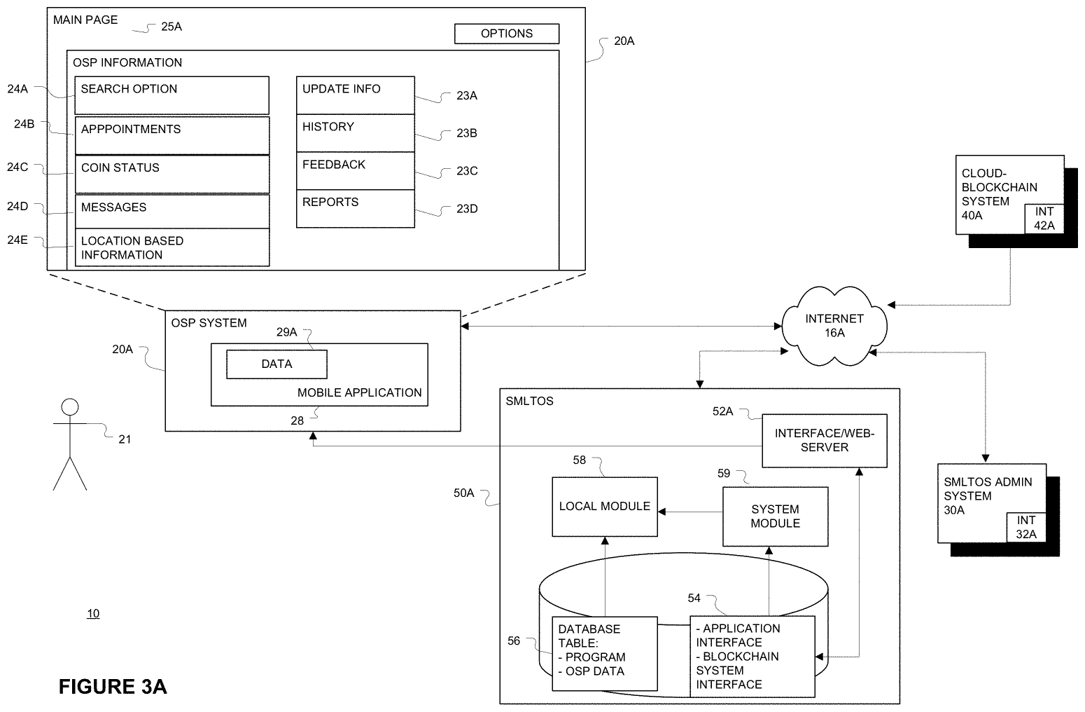

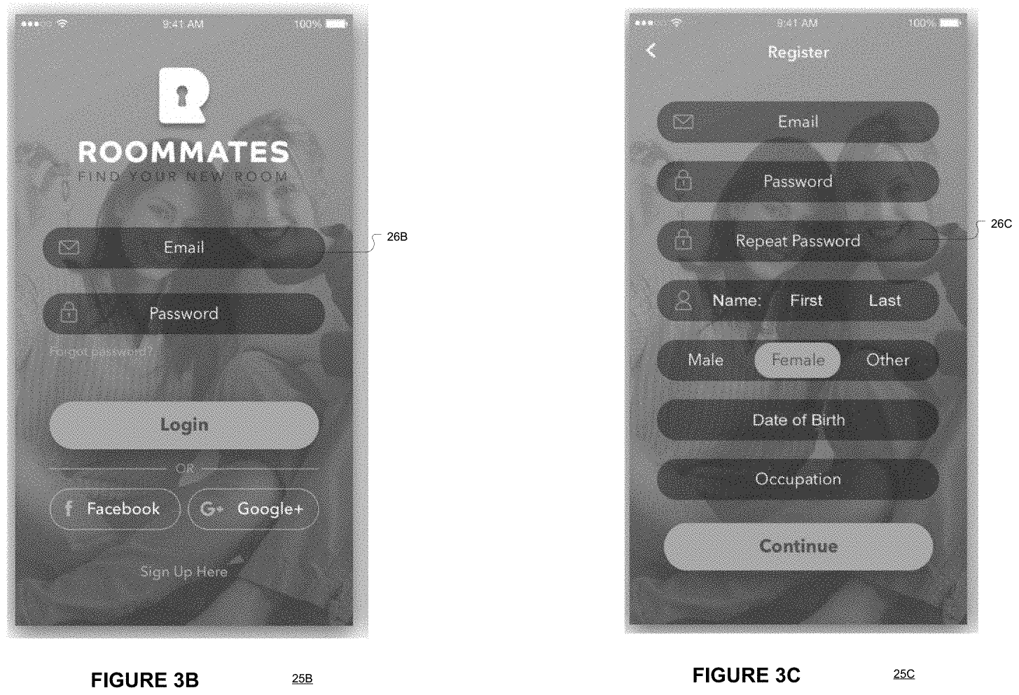

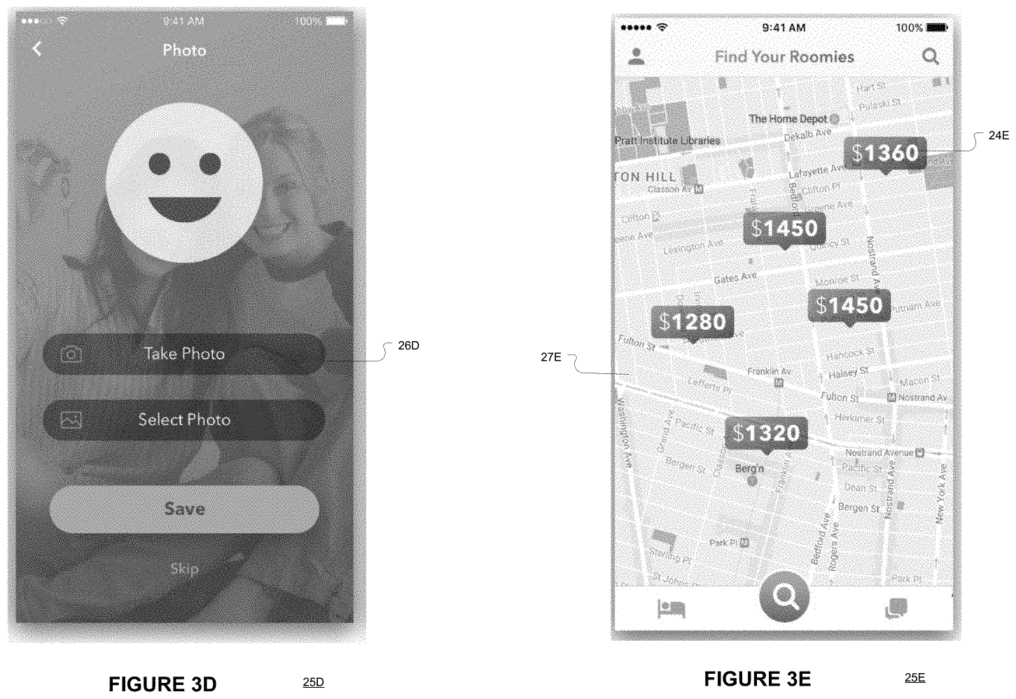

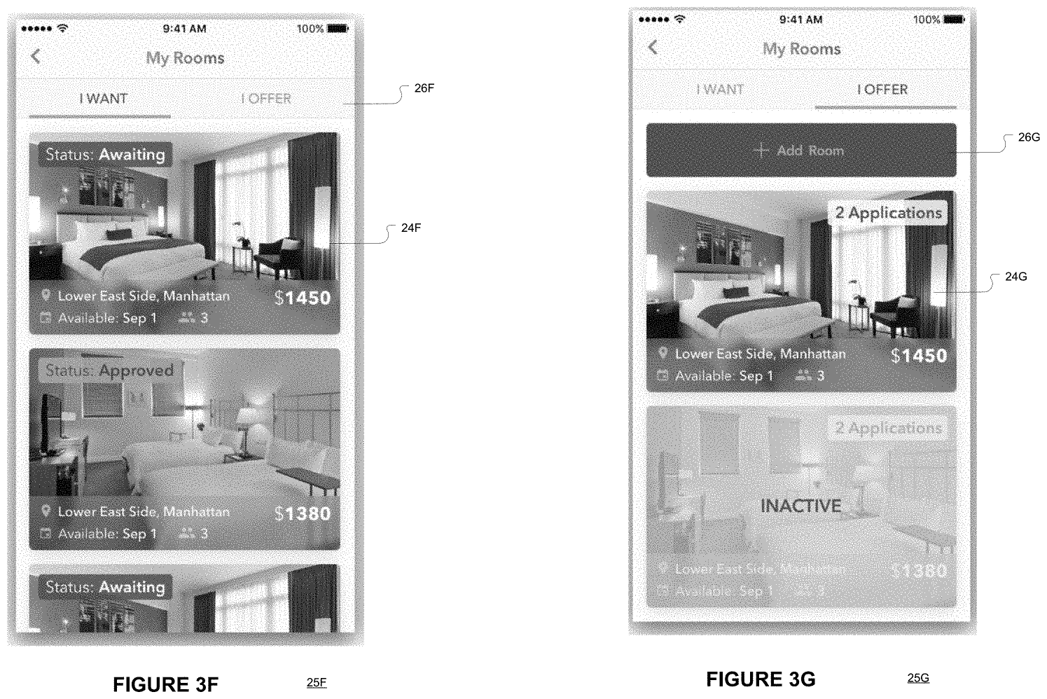

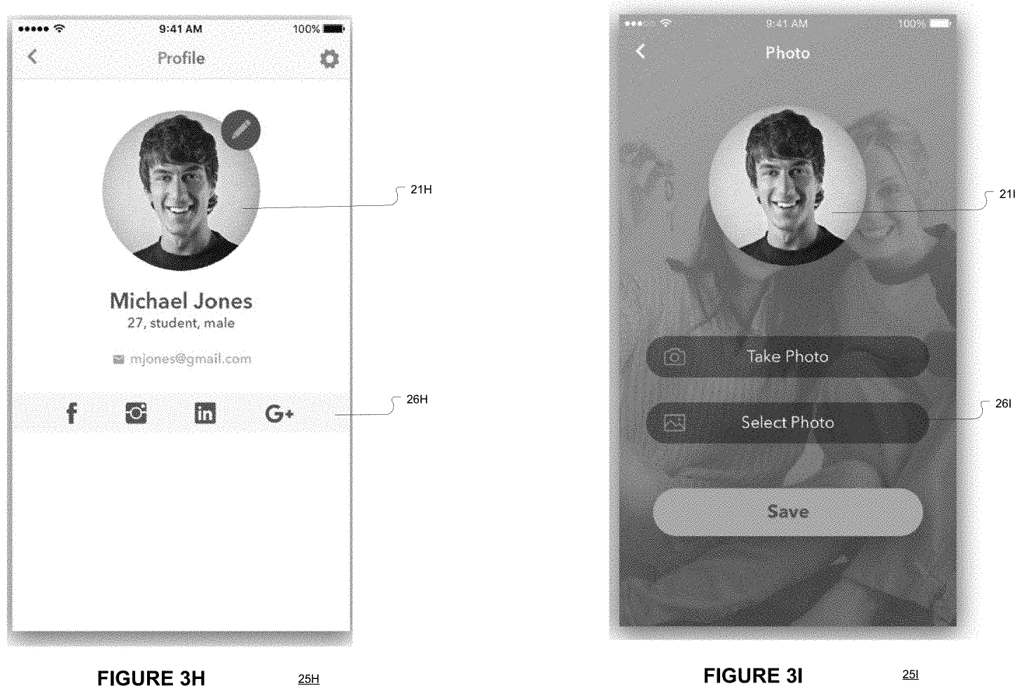

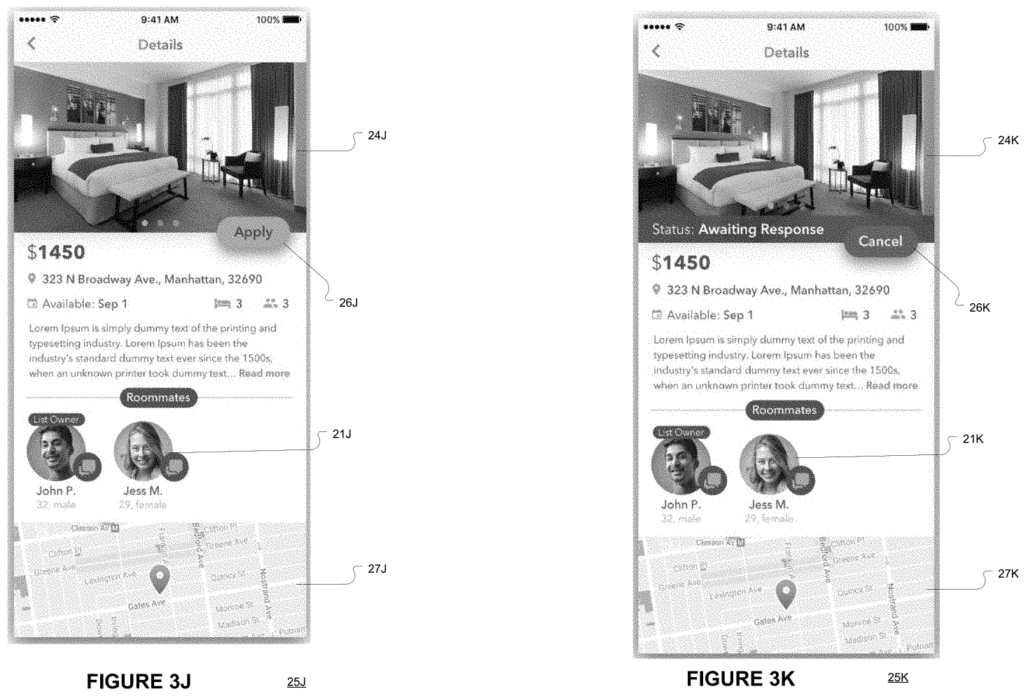

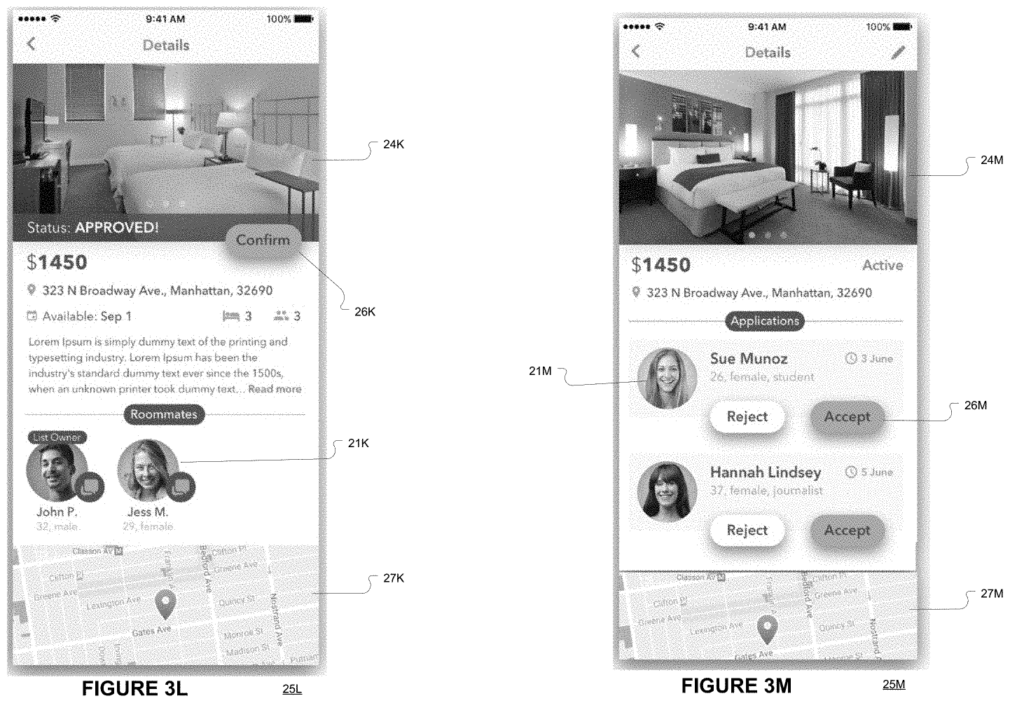

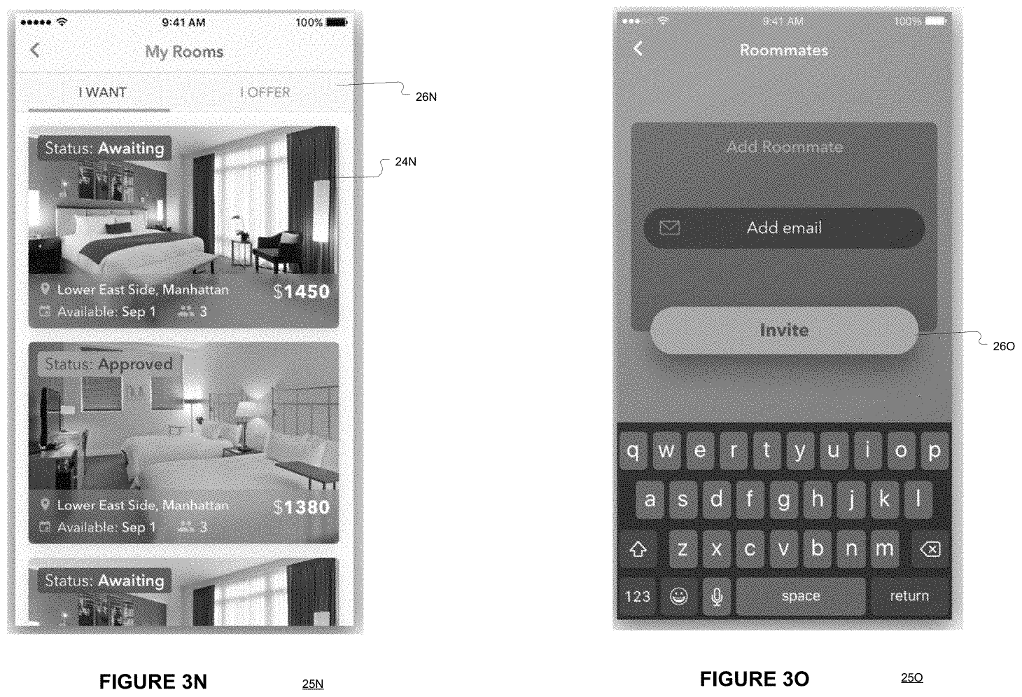

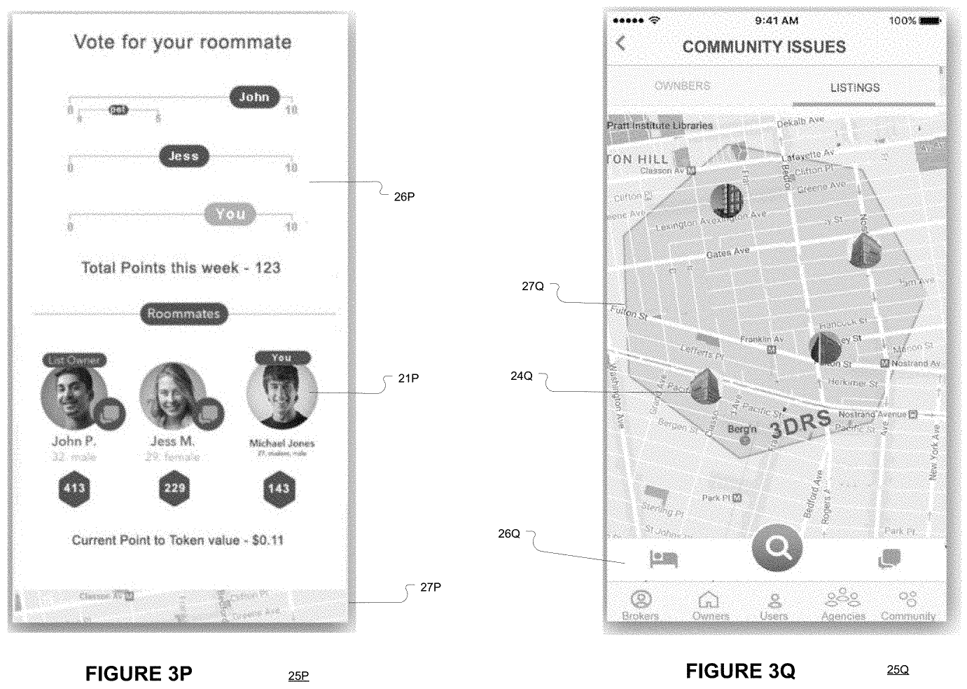

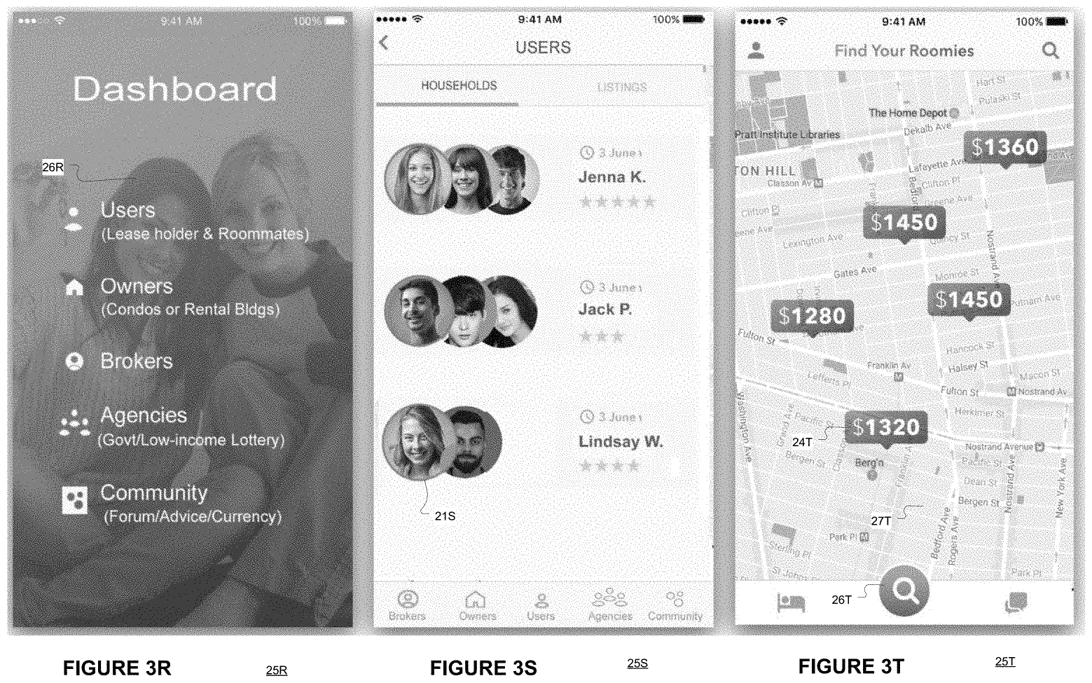

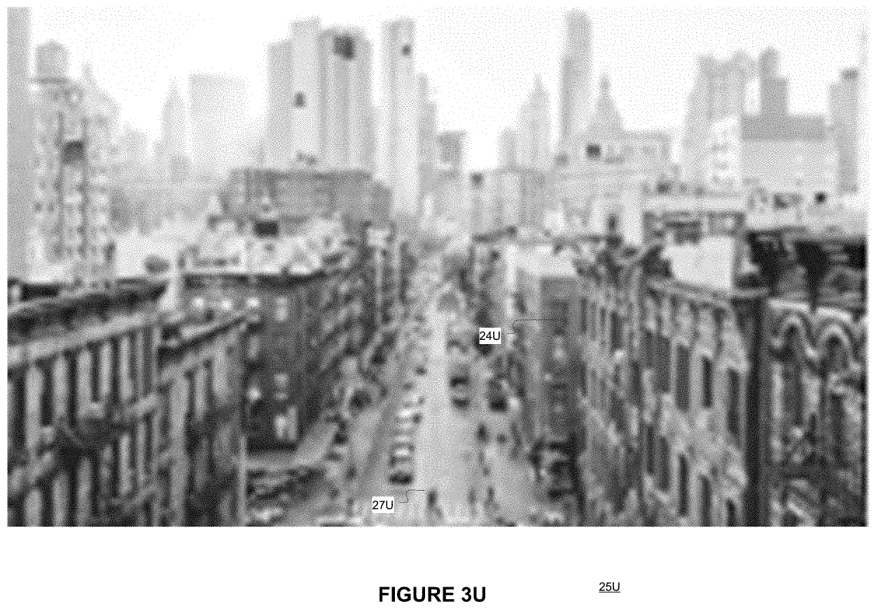

In an embodiment as shown in FIGS. 3A, a SMLTOS system 50A may include an network interface/web-server/software server 52A where the server 52A may be configured to communicate messages, graphical user interfaces, virtual reality (VR), augmented reality (AR), software, data for applications on an OSP system 20A via its interface 22A, SMLTOS admin system 30A via its interface 32A, and CBCS 40A via its interface 42A, and other content. In an embodiment, an OSP system 20A may host an application 28 including a web browser such as Internet Explorer, Safari, Netscape, Chrome, Firefox, or Opera, VR system, or AR system that may be configured to communicate messages and content with a SMLTOS system 50A.

In an embodiment, a CBCS 40A via its network interface 42A, a SAS system 30A via its network interface 32A, and an OSP system 20A via its interface 22A may be any computer device capable of hosting an interface that can communicate with a SMLTOS system 50A including via web browser application 28, runtime application, VR system, AR system, application programming interface (API), or other application as noted. A CBCS 40A, SMLTOS admin system 30A, and an OSP system 20A may include a processor with a network interface 42A, 32A, 22A including a server, virtual server or system, personal computer, personal data assistant, cellular phone, or tablet computer.

In an embodiment, a SMLTOS system 50A may employ a web framework (WF) or web application framework (WAF) including Ruby on Rails, Java, Python, Apache, Django, or other software or architecture to provide web pages, framework, or wire frames to an OSP system 20A. A SMLTOS system 50A may also employ Software as a Service (SaaS) to provide data and executable instructions to an OSP system 20A and the SMLTOS system 50A webpages may be built using on a Rudy on Rails framework or other web frameworks. In an embodiment, an OSP system 20A may host an application operating natively where the application communicates data with the SMLTOS system 50A (such as application downloaded from an application provider or provided by the SMLTOS system 50A). AN OSP system 20A may use various operating systems including Microsoft operating systems (Windows), Linux, Mac OS X, Android, WEB OS, and others to run a SMLTOS interface program or web browser. In an embodiment, a SMLTOS system 50A may provide an interface application to run natively on an OSP system 20A. Such an interface may enable VR system, or AR systems to operate on an OSP system 20A.

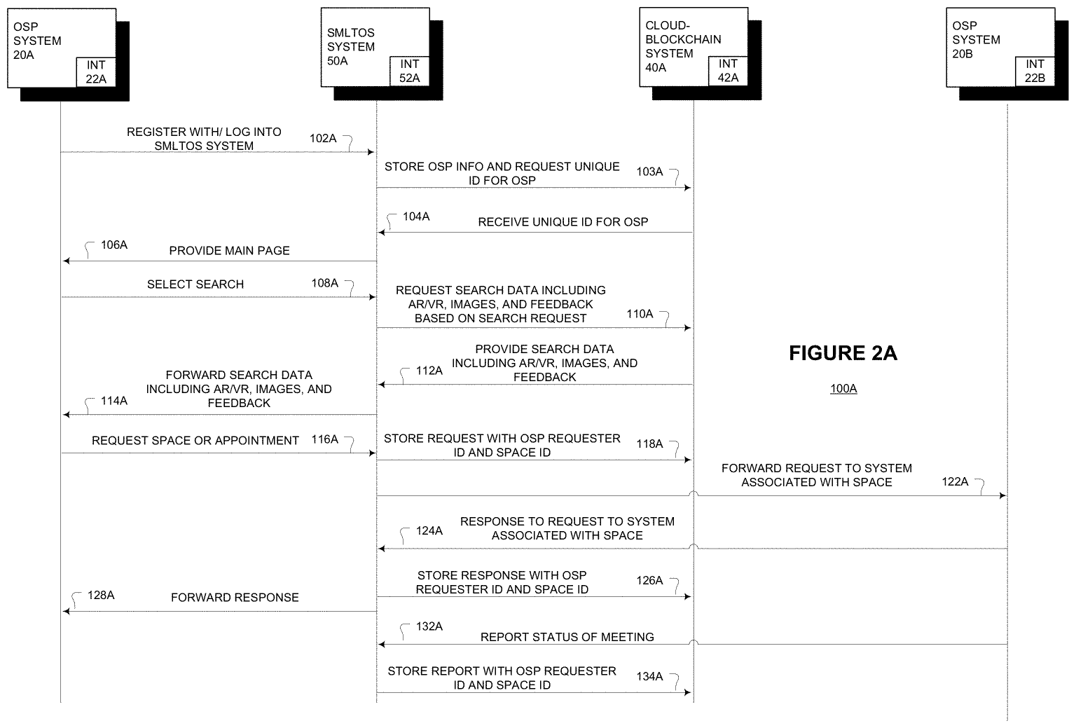

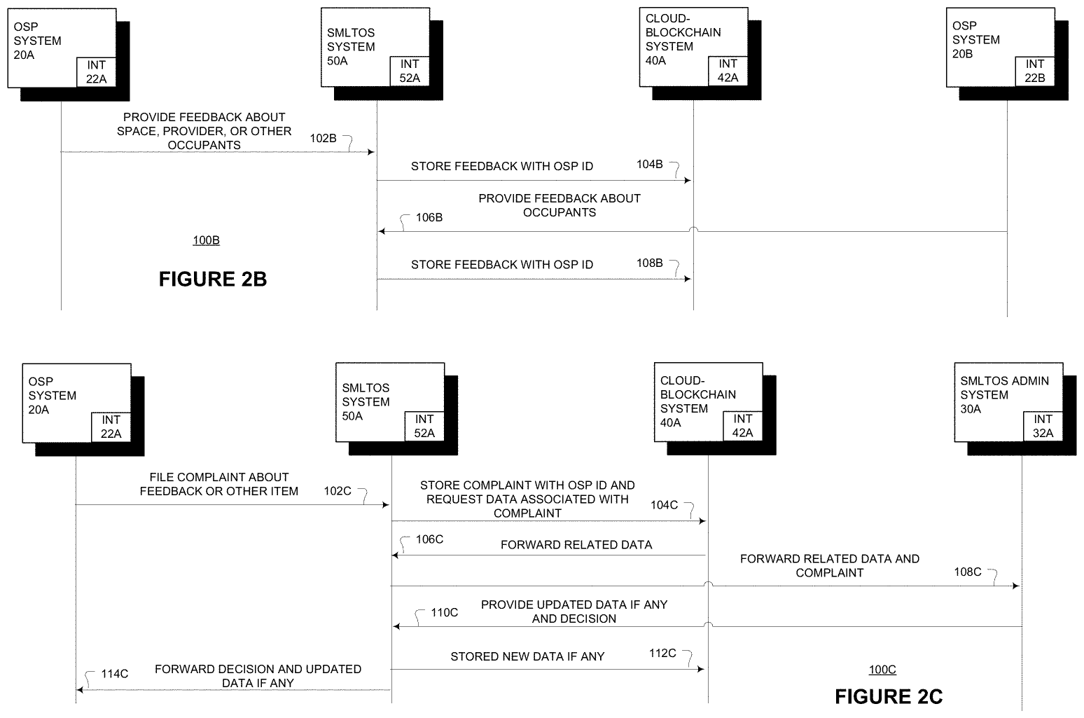

FIGS. 2A-2B are diagrams of communications between a tenant OSP system 20A, a SMLTOS system 50A, a CBCS 40A, and a landlord OSP system 20B according to various embodiments. To protect architecture 10 confidential information a tenant or landlord/space provider may be required to register with a SMLTOS 50A initially—communications 102A-104A. FIGS. 5A is a flow diagram illustrating a method 150A of registering a tenant or space provider according to various embodiments. As shown in FIGS. 2A and 5A, a SMLTOS system 50A may receive a registration/login request (communication 102A), activity 152A, forward initial tenant and space provider information to a CBCS 40A for encrypted and distributed storage (communications 103A) and request a unique ID for the new tenant or space provider (activity 154A). This unique ID for a tenant or landlord may allow them to create a secure history in the architecture 10 so other users may know their reputation as they move or obtain/lease different space(s) over time.

In an embodiment, the unique ID or IDs for the new tenant or space provider or listing(s) or space(s) may include one or more blockchain tokens that uniquely and securely is associated only with the new tenant or space provider or listing(s) or space(s). The SMLTOS system 50A may receive and store the generated unique ID(s) or token(s) for the new tenant or space provider (communications 104A) activity 156A. FIG. 3C is an OSP system 20A interface 25C of a registration page for an OSP system 20A where a user 21A may make selections 26A according to an embodiment. FIG. 3B is an OSP system 20A interface 25B of a login page for an OSP system 20A where a user 21A may make selections 26B according to an embodiment.

Once registered, a User 21A may login into a SMLTOS system 50A via an OPS 20A thereafter using secured protocols. A tenant or space provider may be able to create a profile via OSP system 20A interface 25H of FIG. 3H and add images 21H, 21I to their profile via OSP system 20A interface 25H, 25I via selections 26H, 26I as shown in FIG. 3I.

Once registered or logged into a SMLTOS system 50A, a SMLTOS system 50A may generate and provide/forward a main page 106A (communication 106A) to an OSP system 20A via a network 16, such as the graphical user interface screens 25A and 25R shown in architecture 10 in FIG. 3A and FIG. 3R. As shown in FIG. 3A, a SMLTOS system 50A may include a network/web-server 52A, application interfaces and blockchain system interfaces/protocols 54, OSP tenants/space provider tables/databases 56, a local module 58, and a system module 59. The system module 59 may develop requests and processes responses from CBCSs 40A and SMLTOS admin system 30A. The local module 58 may interface with the User table/database 56 and communicate data between the interface/webserver 52A and the database 56. The User database 56 may include program data for the local module 58, system module 59, and interface/web-server 52A and OSP 20A tenant/space provider data.

The tenant/space provider data may include unique ID(s) created for the tenant/space provider data and tenant/space provider data information. The application interfaces and blockchain system interfaces/protocols 54 may include data associated with interfacing with the CBCSs 40A, OSP 20A, SMLTOS admin system 30A in an embodiment. As also shown in FIG. 3A, a main page 25A for a tenant as generated by a SMLTOS system 50A may include search options for spaces 24A, appointments to view spaces 24B, coin or token status 24C, messages from SMLTOS 50A or other OSP 20B, location based information 24E, update information option 23A, history selection 23B, feedback review selection 23C, and report selection option 23D.

When a tenant or potential tenant selects the search option 24A via communication 108A of FIG. 2A, a SMLTOS system 50A may invoke algorithm 150B shown in FIG. 5B (activity 152B). In an embodiment, the search option may enable the tenant via the OSP system 20A to specify various options for the search results including room size, number of roommates if any, location or radius of acceptable location, costs, availability, length of tenancy. In an embodiment, the current location the OSP system 20A may be communicated via the search options in the communication 108A to SMLTOS system 50A.

Based on the search options, a SMLTOS system 50A may request space data from CBCS 40A (communication 110A and activity 154B) and process the data received from the CBCS 40A (communication 112A and activity 156B) for use by an OSP system 20A as a function of the operating system, mobile application, web browser or other application (such as VR 25U shown in FIG. 3U, AR 25N shown in FIG. 3N) that may display the search results on the OSP system 20A and forward the formatted data to the OSP system 158B (activity 158B and communication 114A). In an embodiment, the search data may be provided in real time such as augmented reality (AR) and virtual reality (VR) data where the AR may include digital elements added to a live view on the OSP system 20A. In an embodiment, as an OSP system 20A is moved AR data may be presented to show spaces information and images associated with the orientation of the OSP system 20A such as an OSP system 20A interfaces 25E-G, 25J-M, and 25T as shown in FIG. 3E-G, 3J-M, and 3T.

Similarly, the VR information may able a viewer of the OSP system 20A to experience a complete immersion experience of the space(s) and related environment such as shown FIG. 3U where a User can see available spaces 24U within a geographical location or map 27U. The AR, VR, and other space(s) 24 based on the search criteria may be provided in batch or real-time as a function of bandwidth and limitation of the respective OSP system 20A. A tenant via an OSP system 20A may then select one or more spaces 24N that they want to see or select 26N via an OSP system 20A interface such as interface 25N of FIG. 3N (communication 116A and activity 162B). The response from the space provider(s) OSP system(s) 20B (communication 124A) may be stored in a CBCS 40A (communication 126A) by a SMLTOS system 50A. A SMLTOS system 50A may forward the response(s) to the tenant OSP system 20A (communication 128A). If the tenant and space provider have a physical meeting to view the space 24, the space provider via their OSP system 20B may forward the status of the meeting (communication 132A and activity 172B and 174B). A SMLTOS system 50A may store the report in a CBCS 40A (communication 134A). In an embodiment, the response may be offering the space to the tenant.

A SMLTOS system 50A may store the space or appointment request communication 116A in a CBCS 40A (communication 118A and activity 164B) with the requestor ID. A SMLTOS system 50A may forward the request(s) to the space provider(s)' OSP system(s) 20B (communication 122A and activity 164B).

As shown in FIG. 3A, feedback review selection 23C may be elected to provide feedback about a space 24Q in a geographical area 27Q, provider 21P, or other occupants 21P (communication 102B of FIG. 2B for tenant and communication 106B from a space provider) such as via interfaces 25P and 25Q shown in FIGS. 3P and 3Q. A SMLTOS 50A may store the feedback from the tenant or space provider in a CBCS 40A (communications 104B, 108B). In an embodiment, a tenant or space provider may file a complaint about feedback or other items to a SMLTOS 50A via an OSP system 20A (communication 102C of FIG. 2C).

In an embodiment, a SMLTOS system 50A may store all complaints in a CBCS 40A and request related data (communication 104C). A CBCS 40A may forward the requested related data to a SMLTOS 50A (communication 106C). A SMLTOS 50A may forward formatted related data and complaint to a SMLTOS admin system 30A for administrative review (communication 108C). A SMLTOS admin system 30A may forward the administrative review decision (communication 110C). A SMLTOS 50A may store the decision and any new data in a CBCS 40A and forward the decision and updated data (such as updated feedback) to an OSP system 20A (communications 112C and 114C).

As shown in FIG. 3A, a User via the main page 25A may be able to request to update their information 23A, see update history 23B, manage vendors via a vendor page 23C, and generate various reports 23D. FIG. 3B is a block diagram of SMLTOS architecture 10 communicating a vendor page 25B to an OSP system 20A according to various embodiments. As shown in FIG. 3B, the Vendor page 25B may include vendor information 25A-25E and selectable activities 26A-26D. The vendor information may include the vendor name(s) 25A, address(es) 25B, email(s) (primary and others) 25C, webpage(s) 25D including User information update pages, and User account number(s) 25E. The activities may include updating the Vendor information 26A, obtaining Vendor history 26B, providing the User's login information for the vendor 26C, and generating reports specific for the vendor 26D.

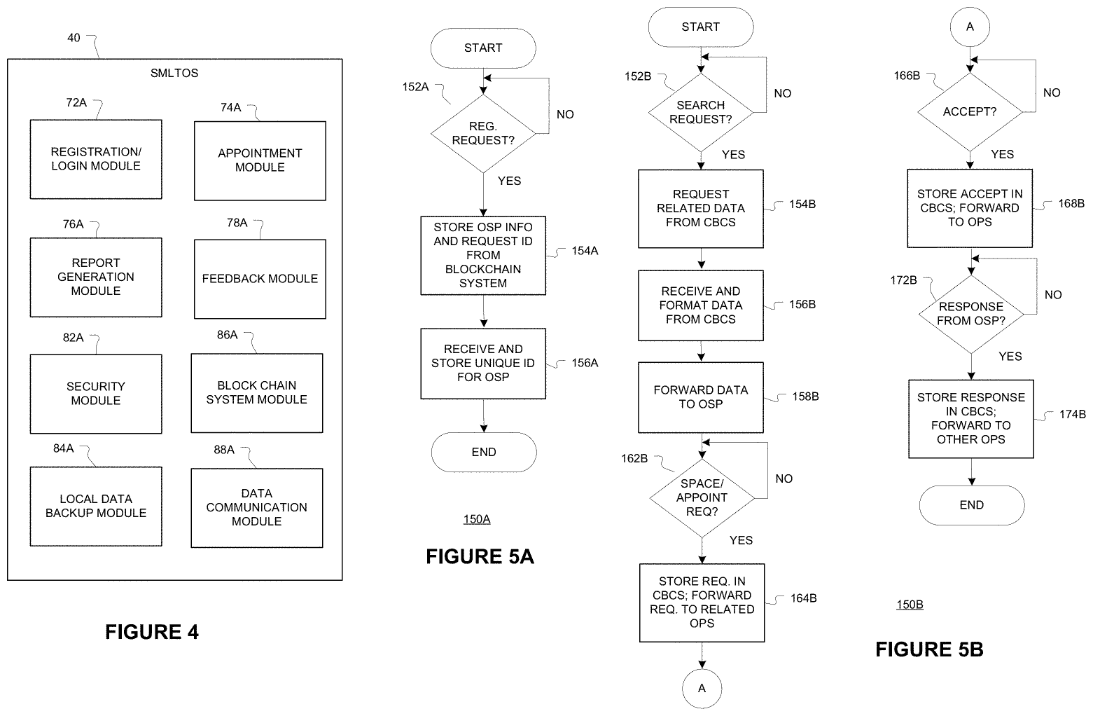

FIG. 4 is a block diagram of a SMLTOS system 50A modules according to various embodiments. As shown in FIG. 4, a SMLTOS system 50A may include a registration/login module 72A, an appointment module 74A, a report generation module 76A, a feedback module 78A, a security module 82A, a cryptography or block chain module 86A, a local data backup module 84A, and a data communication module 88A. The registration/login module 72A along with the blockchain module may be used to request and obtain a unique ID or token for a new tenant, space provider, or space of SMLTOS architecture 10 and enable future logins for the tenant or space provider.

The appointment module 74A along with the blockchain module 86A (in an embodiment) may be used in part to enable a tenant to request an appointment to view a space 24. The report generation module 76A may be able to generate various reports based on space 24 and feedback information including current tenant or space provider related information. The reports may include monthly expenditures reports and others. The feedback module 78A may enable tenant or space provider 21 to provide feedback as noted. The security module 82A may work with the other modules to provide required levels of security to communicate with an OSP system 20A, SMLTOS admin system 30A, and CBCS 40A. The local data backup module may continuously or periodically back up data stored in the databases 54, 56.

In an embodiment, a User 21 using a OPS 20A interface 25E, 25U shown in FIGS. 3E and 3U may be able to see space(s) 24E, 24U available within an environment 27E, 27U. The interface 25E may also including pricing for various spaces. Similarly, a User 21 using a OPS 20A interface 25F, 25G shown in FIGS. 3F and 3G may be able to see status of space(s) 24F, 24G including rooms or spaces a User is offering (for rent—I Offer) or they want to rent (I want) via a selection 26F, 26G. As noted a User 21H, 21I via an OPS 20A interface 25H, 25I may be able to provide their image and demographical information via selections 26H, 26I.

A User may be able to see details about a space 24J, 24K via interface 25J, 25K as shown in FIGS. 3J and 3K including information about current roommates 21J, 21K of some portion of the space(s) 24J, 24K and be able select or deselect 26J, 26K an application for the space 24J. Once approved, a User 21A via interface 25L shown in FIG. 3L may be able to confirm via selection 26K to lease a space 24K. A landlord or existing roommate of a space 24M may be able to view and accept or reject via a selection 26M Users 21M that have applied to lease the space 24M as shown in interface 25M of FIG. 3M.

In an embodiment, the databases 54, 56 may employ Greenplum (www.greenplum.com), Hadoop (hadoop.apache.org) HTTP Filer Server (HFS), PostgreSQL (www.postgresq1.org) software, and other software and hardware to maintain the databases 54, 56. A SMLTOS system 50 may also store data on one or more cloud clusters or distributed systems. The data communication module may enable a SMLTOS system 50A to communicate over various networks using different protocols.

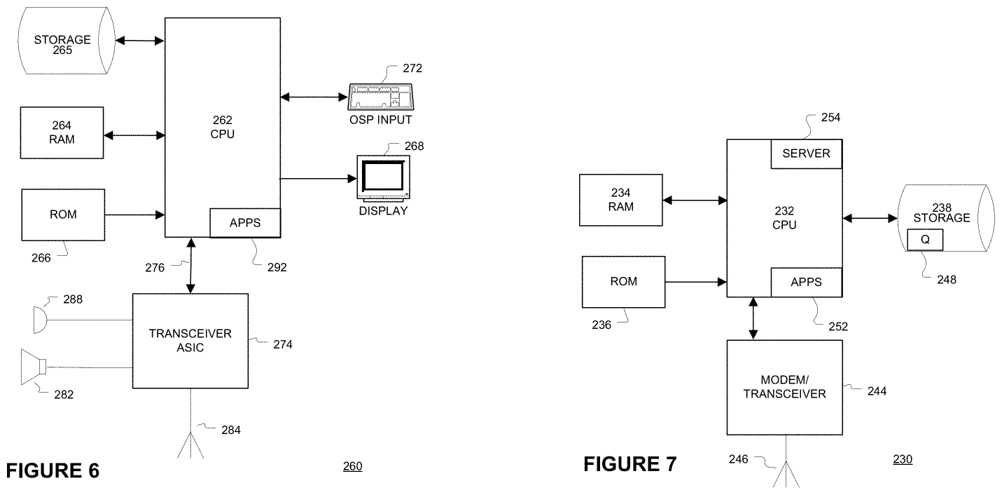

A device 260 is shown in FIG. 6 that may be used in various embodiments as an OSP system 20A or SMLTOS admin system 30A. The device 260 may include a central processing unit (CPU) 262, a random-access memory (RAM) 264, a read only memory (ROM″) 266, a display 268, a user input device 272, a transceiver application specific integrated circuit (ASIC) 274, a microphone 288, a speaker 282, a storage unit 265, and an antenna 284. The CPU 262 may include an application module 292 including an application module 292. The RAM 264 may store SMLTOS system 50A provided content.

In an embodiment, the applications 292 may be a separate module. The application module 292 may process messages, displays, or pages from and generate messages, display, responses, or pages for the SMLTOS system 50A server 52. The storage 265 may store data provided by the SMLTOS system 50A server 52. The storage device 265 may comprise any convenient form of data storage and may be used to store temporary program information, queues, databases, and overhead information.

The ROM 266 may be coupled to the CPU 262 and may store the program instructions to be executed by the CPU 262, and the application module 292. The RAM 264 may be coupled to the CPU 262 and may store temporary program data, and overhead information. The user input device 272 may comprise an input device such as a keypad, touch screen, track ball or other similar input device that allows the user to navigate through menus, displays in order to operate the device 260. The display 268 may be an output device such as a CRT, LCD, touch screen, or other similar screen display that enables the user to read, view, or hear received messages, displays, or pages from the SMLTOS system 50A server 52.

A microphone 288 and a speaker 282 may be incorporated into the device 260. The microphone 288 and speaker 282 may also be separated from the device 260. Received data may be transmitted to the CPU 262 via a bus 276 where the data may include messages, displays, or pages received, messages, displays, or pages to be transmitted, or protocol information. The transceiver ASIC 274 may include an instruction set necessary to communicate messages, displays, or pages in architecture 10. The ASIC 274 may be coupled to the antenna 284 to communicate wireless messages, displays, or pages within the architecture 10. When a message is received by the transceiver ASIC 274, its corresponding data may be transferred to the CPU 262 via the bus 276. The data can include wireless protocol, overhead information, and pages and displays to be processed by the device 260 in accordance with the methods described herein.

FIG. 7 illustrates a block diagram of a device 230 that may be employed as a SMLTOS system 50A-B or CBCS 40A-B in various embodiments. The device 230 may include a CPU 232, a RAM 234, a ROM 236, a storage unit 238, a modem/transceiver 244, and an antenna 246. The CPU 232 may include a web-server 254 and application module 252. The RAM 234 may include a queue or database 248 where the database 248 may be used to store information including tenant, space provider, or space information, related data, and statistics. The storage 238 may also include a queue or database 256 where the database 256 may be used to store tenant, space provider, or space information. In an embodiment, the server 254 and the application module 252 may be separate elements. In an embodiment, the server 254 may generate content for web-pages or displays to be forwarded to an OSP system 20A.

The modem/transceiver 244 may couple, in a well-known manner, the device 230 to the network 16 to enable communication with an OSP system 20A or other systems 30A, 40A, 50A. In an embodiment, the modem/transceiver 244 may be a wireless modem or other communication device that may enable communication with a an OSP system 20A or other systems 30A, 40A, 50A. The CPU 232 via the server 254 may direct communication between modem 244 and a an OSP system 20A or other systems 30A, 40A, 50A.

The ROM 236 may store program instructions to be executed by the CPU 232, server 254, or application module 252. The RAM 234 may be used to store temporary program information, queues, databases, and overhead information. The storage device 238 may comprise any convenient form of data storage and may be used to store temporary program information, queues, databases, and overhead information.

Any of the components previously described can be implemented in a number of ways, including embodiments in software. Any of the components previously described can be implemented in a number of ways, including embodiments in software. Thus, the CPU 232, server 254, application module 252, modem/transceiver 244, antenna 246, storage 238, RAM 234, ROM 236, database 248, database 256, CPU 262, application module 292, transceiver ASIC 274, antenna 284, microphone 288, speaker 282, ROM 266, RAM 264, database 267, user input 272, display 268, SMLTOS system 50A, CBCS 40A, SMLTOS admin system 30A, and, OSP system 20A, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A computer-implemented method of enabling users of a system to securely lease or rent one of a plurality of spaces, the method comprising:
generating encrypted unique identifiers for each User of the system including Users leasing and requesting to lease a space of the plurality of spaces and Users renting or requesting to rent a space of the plurality of spaces;
generating an encrypted unique identifier for each space of the plurality of spaces; and
electronically forwarding a request to lease a space of the plurality of spaces or rent the plurality of spaces to a User system associated with the respective space via the associated unique identifiers based on a request of a User of another User system.

2. The computer-implemented method of claim 1, wherein generating encrypted unique identifiers for a User includes generating a block chain encrypted unique identifier for the User.

3. The computer-implemented method of claim 1, wherein generating encrypted unique identifiers for each space of the plurality of spaces includes generating a block chain encrypted unique identifier for the for each space of the plurality of spaces.

4. The computer-implemented method of claim 2, wherein each forwarded request is assigned a unique identifier associated with both the requesting Users unique identifier and the respective space unique identifier.

5. The computer-implemented method of claim 1, wherein at least one spaces of the plurality of spaces is configured to be shared by a User of system.

6. The computer-implemented method of claim 5, further including enabling a User to provide feedback about a space of the plurality of spaces.

7. The computer-implemented method of claim 1, further including enabling a User of the system to request a list of spaces of the plurality of spaces that meet certain criteria.

8. The computer-implemented method of claim 7, wherein the criteria includes the distance from the User's system.

9. The computer-implemented method of claim 1, further including enabling a User of the system to request a view an image of spaces of the plurality of spaces that meet certain criteria.

10. The computer-implemented method of claim 1, further including enabling a User of the system to request a view an image of spaces of the plurality of spaces within a geographical environment that is also visually depicted.

11. The computer-implemented method of claim 10, wherein the cost of one of the spaces of the plurality of spaces within a geographical environment is visually shown on the same display.

12. The computer-implemented method of claim 11, wherein the display is one or a virtual reality and augmented reality display.

13. The computer-implemented method of claim 1, wherein the feedback includes information about one of one or more current Users renting the space and a User leasing the space.

14. The computer-implemented method of claim 1, generating encrypted tokens that enable a User to pay for the lease of a space of the plurality of spaces via their User system.

15. The computer-implemented method of claim 1, generating block chain encrypted tokens that enable a User to pay for the lease of a space of the plurality of spaces via their User system.

16. The computer-implemented method of claim 1, generating encrypted tokens that enable a User to grant an rewards for other a User that is leasing a space of the plurality of spaces via their User system.

17. The computer-implemented method of claim 1, generating block chain encrypted tokens that enable a User to grant an rewards for other a User that is leasing a space of the plurality of spaces via their User system.

18. The computer-implemented method of claim 1, further including enabling a User of the system to request a view an image of spaces and the current other renters of the plurality of spaces that meet certain criteria.

19. The computer-implemented method of claim 1, further including enabling a User of the system to request a view an image of spaces and the current other renters of the plurality of spaces within a geographical environment that is also visually depicted.

20. The computer-implemented method of claim 19, wherein the cost of one of the spaces of the plurality of spaces within a geographical environment is visually shown on the same display.
